(19) United States
(12) Patent Application Publication
(10) Pub. No.: US 2026/0361529 A1
(43) Pub. Date: Nov. 12, 2026

(54) LOW FOOTPRINT AND MEMORY EFFICIENT HARDWARE ARCHITECTURE CONFIGURABLE TO SUPPORT A PLURALITY OF CRYPTOGRAPHIC HARDWARE MODULES

(71) Applicant: PQSecure Technologies, LLC, Boca Raton, FL (US)

(72) Inventors: Luke Beckwith, Sterling, VA (US); Abubakr Abdulgadir, Reston, VA (US); Rami Elkhatib, Boca Raton, FL (US)

(73) Assignee: PQSecure Technologies, LLC, Boca Raton, FL (US)

(21) Appl. No.: 19/599,264

(22) PCT Filed: Dec. 7, 2023
(86) PCT No.: PCT/US2023/082973

§ 371 Date: Jun. 18, 2026

(51) Int. Cl. H04L 9/08; H04L 9/06

(52) U.S. Cl. CPC H04L 9/0869; H04L 9/0643

(57) ABSTRACT

A low footprint and memory efficient hardware architecture configurable to support a plurality of cryptographic hardware modules and supporting various algorithms covering a wide range of applications. The architecture provides a simple interface, low area and memory footprint, and power side-channel protection by including a plurality of side-channel protected hardware modules operably configured to perform at least one side-channel protected cryptographic algorithm, a Type A memory module, a Type B memory module, a random number generator, a plurality of interconnects configured to selectively transfer the type A algorithm data, type B algorithm data, and random data, and a system controller operably configured to manage the selective transfer used by the plurality of interconnects and manage a state of the plurality of side-channel protected hardware modules and a state of the random number generator.

### FIELD OF THE INVENTION

This disclosure relates to cryptographic hardware architectures for “post-quantum” or “quantum-resistant” cryptographic algorithms useful for Hardware Security Modules (HSMs), Trusted Platform Modules (TPMs), and similar security applications including data encryption, authenticated key exchange, and secure boot.

### BACKGROUND OF THE INVENTION

Public key and secret key cryptography are utilized in nearly every aspect of computing, from lightweight Internet-of-Things (IoT) devices to High-Performance Computing (HPC). Secret key encryption is used to secure data at rest and in transit through the use of symmetric ciphers, such as the Advanced Encryption Standard (AES). Public key encryption is used for secure key exchange and authentication of data integrity and sender identity. Other cryptographic services include hashing, such as the Secure Hash Algorithms version 2 and 3 (SHA-2/SHA-3). Hashing may be used to verify the integrity of data after transmission by comparing the expected hash of the data with the actual result of the hash, or as the first step in a hash-and-sign operation.

Traditionally, public key encryption was built upon the integer factorization problem (i.e., RSA) or the discrete logarithm problem (i.e., ECC). However, these problems become possible to solve given a large enough quantum computer running Shor's algorithm. Thus, significant effort has been made to develop new encryption and digital signatures algorithms which are not vulnerable to quantum computing attacks, such as the new NIST standards ML-KEM, ML-DSA, and SLH-DSA. These algorithms are based on mathematical problems which are believed to be difficult to solve using both classical and quantum computers. In addition to these new algorithms, the stateful hash signatures XMSS and LMS are also considered to be secure against quantum computing attacks. This class of cryptographic algorithm which is secure against quantum and classical computing attacks is referred to as “post-quantum”, “quantum-resistant”, or “quantum-safe”.

These cryptographic services are widely used in all forms of computing. Secure IoT devices use digital signature algorithms to verify commands are from a valid sender and use public and secret key cryptography to secure data in transit. Similarly, HPC systems and consumer computers use certificates to verify network communications and may use secret key encryption to encrypt stored data.

Due to the ubiquity of these algorithms, it is beneficial to provide specialized hardware implementing cryptographic algorithms. Specialized hardware is able to perform the cryptographic operations with lower latency, power, and energy when compared to general-purpose processors. Hardware implementations are also easier to protect against power and timing side-channel attacks, wherein secret information is recovered by observing the power consumption or timing of the cryptographic operation. Further, cryptographic hardware implementations can be easily integrated into specialized security modules such as Hardware Security Modules (HSMs) and Trusted Platform Modules (TPMs) which provide additional services including, but not limited to, key management and secure boot.

However, while these various platforms all utilize cryptographic algorithms, their specific needs vary significantly. A lightweight IoT client device may only need to verify that commands it receives are valid or encrypt a message payload. Client devices often do not need to generate signatures. Thus, this device would only require hardware for symmetric data encryption (AES) and digital signature verification (ML-DSA, XMSS, LMS, etc.). On the other hand, an HPC system handling internet traffic may be generating thousands of signatures a minute. Thus, it would benefit from hardware accelerator of the signature generation functions. A specialized security module, such as a TPM, may only require the ability to verify firmware signatures generated by a stateful signature such as XMSS or LMS.

Thus, it is beneficial to have a hardware architecture which can be configured to provide cryptographic services for a wide variety of applications. However, this flexibility must not come at the cost of security, performance, or silicon area. This architecture must also be resilient against quantum computing and side-channel attacks.

### SUMMARY OF THE INVENTION

The invention provides a hardware architecture for a power side-channel protected and low silicon area cryptographic accelerator which can be configured to support a wide range of applications. Said differently, the present invention discloses a low footprint and memory efficient hardware architecture configurable to support a plurality of cryptographic hardware security modules.

Said another way, the architecture is composed of a series of configurable cryptographic modules, a set of memory modules, a module for generating random numbers, and a plurality of interconnects. The architecture may support the following algorithms or any subset of the following algorithms: AES, SHA-2, SHA-3, ML-KEM, ML-DSA, XMSS, and LMS. These submodules may be equipped with power side-channel countermeasures which require random data to maintain security. Thus, the architecture is also equipped with a random number generator.

The random number generator may consist of a Pseudorandom Number Generator (PRNG) which uses an externally generated random seed to deterministically generate a series of random numbers. It may also consist of a PRNG connected to an internal True Random Number Generator (TRNG) which generates said seed. Alternatively, it may be a combined TRNG-PRNG which is capable of generating both true random numbers and using deterministic algorithms to generate random numbers.

The architecture contains two memory modules. One optimized for storage of byte-based data such as the input data to the AES module. The second is optimized for storage of the polynomial coefficients used in the ML-KEM and ML-DSA algorithms.

The memories are also used to transfer data between the cryptographic modules as needed. SHA-3 is a primitive used for hashing and sampling of polynomials in ML-KEM and ML-DSA and is used for hashing in LMS and XMSS. Data is transferred from one module to another through these memories.

The cryptographic modules may be configured internally to remove functionality that is not needed for a specific application. For example, a variety of cipher block operation modes may be optionally supported including but not limited to ECB, CTR, CCM, GCM, and XTS. Similarly, the public key algorithms may be configured to support all or a subset of their operation. For example, ML-DSA could be instantiated to support all or a subset of the following operations: Key generation, signature generation, and signature verification.

A simple interface is provided which exposes the control signals of the cryptographic modules. The system controller manages the state of the cryptographic modules and ensures no conflicting operations are performed. Data is transferred directly in and out of the byte-optimized memory.

Although the invention is illustrated and described herein as embodied in a low footprint and memory efficient hardware architecture, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

FIG. 1 is a schematic depicting an instance of our invention configured with support for all algorithms.

FIG. 2 is a schematic depicting the possible configuration for the random number generator module.

FIG. 3 is a schematic depicting a memory layout of the byte optimized memory storing two W-bit shares of data.

FIG. 4 is a schematic depicting several memory layouts of the polynomial optimized memory storing data for various algorithms.

FIG. 5 is a schematic depicting several possible utilizations of the protected SHA3 data output.

FIG. 6 is a schematic depicting possible configurations of the AES module with various operation mode controllers.

FIG. 7 is a schematic depicting possible configurations of the combined ML-KEM and ML-DSA module with various operation controllers.

### DETAILED DESCRIPTION

The present invention provides a hardware architecture for a flexible and configurable cryptographic accelerator which is capable of supporting a wide range of applications. Said invention provides an efficient method of connecting side-channel protected cryptographic modules to a shared set of memories, to a shared random number generator, and optimally utilizing the SHA-3 hash module between multiple cryptographic operations.

In the context of this invention, “side-channel protected” refers to protection against timing attacks, simple power analysis attacks, and differential power analysis attacks. This protection may be achieved through a combination of side-channel countermeasures implemented within the cryptographic modules. Examples of these countermeasures include constant time operation, Boolean masking, arithmetic masking, shuffling, and hiding.

The side-channel protected cryptographic algorithms consist of secret key encryption algorithms, public key encryption algorithms, and secure hashing algorithms. In the context of this invention “public key encryption algorithms” include algorithms for key exchange and for digital signatures.

The architecture may be configured to support the following cryptographic algorithms or a subset of the algorithms: SHA-2, SHA-3, AES, ML-KEM, ML-DSA, XMSS, and LMS. There exist dependencies for several algorithms: if ML-KEM and/or ML-DSA is instantiated, SHA-3 is required; if XMSS and/or LMS is instantiated, either SHA-2 or SHA-3 is required. When both ML-KEM and ML-DSA are instantiated, they share a set of polynomial sampling and polynomial arithmetic modules to reduce the area of the architecture.

The configuration of the inventions refers to the selection of which cryptographic submodules are instantiated in that particular instance of the invention. For example, one possible configuration of the architecture may only include instances of ML-DSA and SHA-3. Another configuration submodules may only include SHA-2 and AES.

It is also possible to configure the cryptographic modules to implement only a subset of their possible operation. For example, AES may be configured with controller modules capable of performing one or many of the following operation modes: CTR, CCM, GCM, CFB ECB, CBC, CBC-MAC, and XTS. A digital signature algorithm may be configured with support for one or many of the following cryptographic operations: key generation, signature generation, signature verification.

During operation of the cryptographic modules, two types of algorithm data are used; “Type A” data is byte-aligned data consisting of W-bit shares which represent a masked W-bit data value, “Type B” data is non-byte aligned data optimized for storing polynomial coefficients. Type A data is used to represent one shared word of SHA-2 data, one shared lane of SHA-3 data, one shared column of AES data, and for the hash, input, and output data of ML-KEM, ML-DSA, XMSS, and LMS. Type B data is used for the intermediate values of ML-KEM, ML-DSA, XMSS, and LMS. In particular, it consists of shares an M-bit coefficient of an ML-DSA polynomial, shares of two M/2-bit of coefficients an ML-KEM polynomial, N-bit unshared entries of a packed ML-KEM or ML-DSA, or N-bit unshared entries of a XMSS or LMS data element.

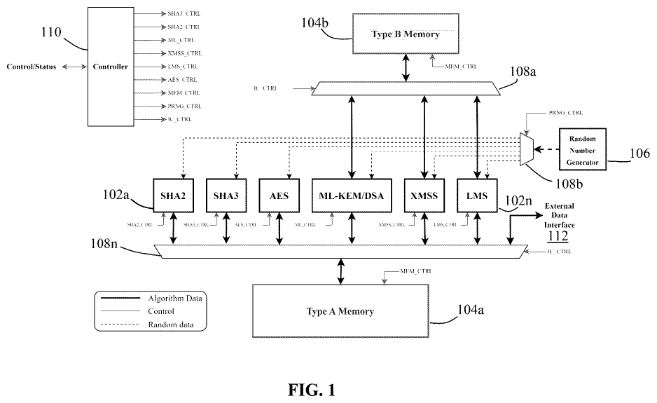

One possible configuration of the architecture is depicted in the schematic diagram shown in FIG. 1. FIG. 1 depicts an exemplary hardware architecture supporting all possible algorithms. The architecture includes cryptographic modules 102a-n (wherein “n” represents any number greater than one), the system controller 110, the Type A memory 104a, the Type B memory 104b, a random number generator 106, and a set of interconnects 108a-n. The random number generator 106 creates a stream or series of random bits which are often interpreted as random numbers. The random numbers produced are used to provide random data to the cryptographic modules. This random data may be used as random seeds required by the cryptographic operation or may be used for side-channel countermeasures which often require random data during their operation. The system controller 110 manages the state of the architecture and ensures that no invalid sequence of commands is performed. In the context of this invention, the “state” of the architecture refers to the status of the cryptographic submodules, i.e., whether they are idle or what operation they are currently performing. For example, if one cryptographic module is currently performing an operation, the controller 110 will ensure that any additional commands that are received do not conflict with the current operation. If invalid commands are received, the controller will ignore the command and signal to the user that the command was rejected. The system controller 110 also manages the interconnect between the cryptographic modules and the memories and random number generator. When the system is receiving or unloading data, the system controller makes the Type A memory available to an external interface.

Another configuration of the architecture may optionally include a secure memory used for storing secret key data. This memory may be connected directly to one or several cryptographic modules or may be connected to the Type A memory. The interconnects in the architecture may be simple multiplexors used as switches to control access to the memories between the modules. It may also be a more complex interconnect utilizing a bus protocol such as the AXI or AMBA protocols.

Data is sent and received from the module through the external interface. This interface connects to the Type A memory through an interconnect controlled by the system controller. Data may be transferred through this interface when all cryptographic modules are idle. This external interface may be used to transfer data from other systems such as a TPM, CPU, or other processing devices.

Stated differently, the low footprint, memory efficient, and hardware architecture exemplified in FIG. 1 is configurable to support a plurality of cryptographic hardware modules by including a plurality of side-channel protected hardware modules 102a-n, a first memory module 104a (“Type A” memory module), a second memory module 104b (“Type B” memory module), a random number generator 106, a plurality of interconnects 108a-n, and a system controller 110 all operable with one another as disclosed herein. The hardware modules 102a-n are operably configured to perform at least one side-channel protected cryptographic algorithm.

The first memory module 104a is configured to receive and store type A algorithm data from an external interface 112 to the hardware architecture and receive and store the type A algorithm data, wherein the type A algorithm data is configured for use during operation of at least one of the plurality of side-channel protected hardware modules 102a-n and utilized in the at least one side-channel protected cryptographic algorithm. The second memory module 104b is configured to receive and store type B algorithm data used during operation of the at least one of the plurality of side-channel protected hardware modules 102a-n and utilized in the at least one side-channel protected cryptographic algorithm. The random number generator 106 is operably configured to generate random data used by the at least one of the plurality of side-channel protected hardware modules 102a-n and the plurality of interconnects 108a-n are specially configured to do at least three things, i.e., selectively transfer (1) the type A algorithm data between the at least one of (i.e., both or one of) the plurality of side-channel protected hardware modules 102a-n and the first memory module 104a or the first memory module 104a and the external interface 112, (2) the type B algorithm data between the at least one of the plurality of side-channel protected hardware modules 102a-n and the second memory module 104b, and (3) the random data between the random number generator and the at least one of the plurality of side-channel protected hardware modules 102a-n. The architecture also includes the system controller 110 operably configured to manage the selective transfer used by the plurality of interconnects 108a-n and manage a state of the plurality of side-channel protected hardware modules 102a-n and a state of the random number generator 106.

When operating, the SHA-2, SHA-3, and AES modules utilize the Type A memory to receive input data, store intermediate calculation results, and write the final output data of the operation. The ML-KEM, ML-DSA, XMSS, and LMS modules utilize both the Type A memory and the Type B memory during their operation. ML-KEM and ML-DSA utilize the Type B memory for polynomial coefficients. XMSS and LMS utilize the Type B memory for non-sensitive data values. For these modules, input data is read from the Type A memory and the final output data is written to Type A memory.

In one embodiment, the system controller 110 is operably configured to manage a state of the first and second memory modules 104a-b. With respect to the plurality of side-channel protected hardware modules 102a-n, one or more of the plurality of side-channel protected hardware modules 102a-n are operably configured to implement at least one secret key encryption, at least one quantum-resistant public key encryption, and at least one hashing operation. The random data depicted in FIG. 1 may also be used by at least one of the plurality of side-channel protected hardware modules 102a-nfor at least one of a side-channel protected operation and a seed generation within the side-channel protected cryptographic algorithm.

Additionally, the Type A algorithm data (represented in FIG. 1 with solid lines) includes at least one of word-aligned SHA-2 shares, lane-aligned SHA-3 shares, and column-aligned AES shares and type B algorithm data includes at least one of two ML-DSA coefficient shares, four ML-KEM coefficient shares, or one word-aligned of an XMSS or LMS data element. Furthermore, the random number generator 106 is also operably configured to generate the random data with at least one of a PRNG module seeded by an external source of randomness, a PRNG module seeded by an internal TRNG module, or a combined PRNG-TRNG module operably configured with both PRNG functionality and TRNG functionality.

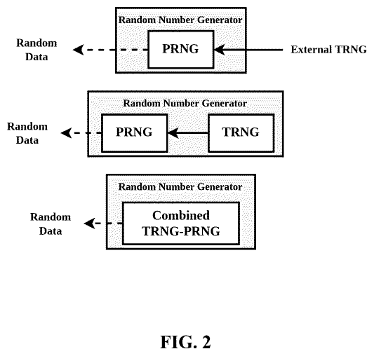

FIG. 2 depicts several possible configurations of the random number generator. In one configuration, it consists of a module implementing a Pseudorandom Number Generator (PRNG), which is a deterministic function that generates a sequence of numbers which approximate the properties of a true sequence of random numbers, based on a seed generated from an external source of randomness. In another configuration, both a module reimplementing a PRNG and a module implementing a True Random Number Generator (TRNG) are utilized. The TRNG generates a random seed which is then used to generate a stream of random numbers from the PRNG. In another instance, a combined PRNG-TRNG module is used which provides the functionality of both a PRNG and a TRNG.

Referring back to FIG. 1, in one embodiment, one of the plurality of side-channel protected hardware modules 102a-n beneficially includes a SHA-3 module configured to perform, with the type A algorithm data, either a protected SHA-3 hash operation with the entire first memory module 104a or multiple parallel unprotected SHA-3 hash operations with each of the unprotected SHA-3 hash operations utilizing a portion of the first memory module 104a. One of the plurality of side-channel protected hardware modules 102a-n may also include a ML-KEM/DSA module configured to perform public sampling operations using the parallel unprotected SHA-3 hash operations and configured to perform secret sampling operations using the protected SHA-3 hash operations.

Furthermore, one of the plurality of side-channel protected hardware modules 102a-n may also beneficially be a ML-KEM/DSA module configured to perform a subset of ML-KEM key generation operations, encapsulate operations, and decapsulate operations within the at least one side-channel protected cryptographic algorithm. One of the plurality of side-channel protected hardware modules 102a-n may also include a ML-KEM/DSA module configured to perform a subset of ML-DSA key generation operations, signature generation operations, and signature verification operations within the at least one side-channel protected cryptographic algorithm. One of the plurality of side-channel protected hardware modules 102a-n may also include an AES module configured to perform a subset of encryption operations and decryption operations.

Additionally, one of the plurality of side-channel protected hardware modules 102a-n may also beneficially include a XMSS module configured to perform a subset of XMSS key generation operations, signature generation operations, and signature verification operations within the at least one side-channel protected cryptographic algorithm. One of the plurality of side-channel protected hardware modules 102a-n may also include a LMS module configured to perform a subset of LMS key generation operations, signature generation operations, and signature verification operations within the at least one side-channel protected cryptographic algorithm. Additionally, one of the plurality of side-channel protected hardware modules 102a-n may also include an AES module configured to perform a subset of the following cipher block modes: CTR, CCM, GCM, CFB ECB, CBC, CBC-MAC, and XTS. In some embodiments, the architecture may include all or some of said side-channel protected hardware modules 102a-n depicted in FIG. 1, making it highly configurable.

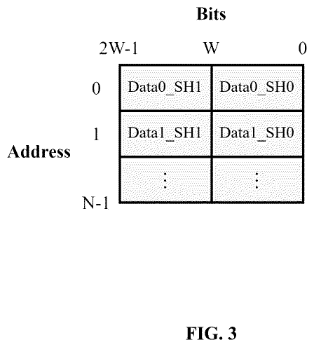

FIG. 3 depicts a possible format of data stored in the Type A memory. The data is split into two W-bit shares as is required for first order masking countermeasures. The first share is stored in the lower W-bits while the second share is stored in the upper W bits. In instances required higher order masking, the memory with is increased by W bits for each additional share.

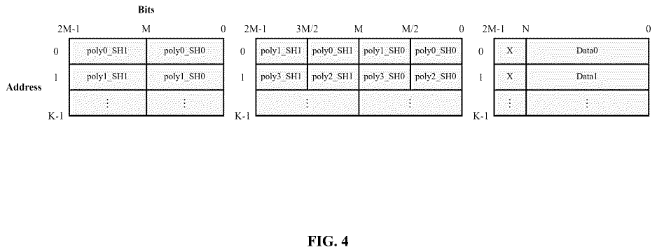

FIG. 4 depicts possible memory formats of data stored in the Type B memory. In one configuration two M-bit shares of a polynomial of ML-DSA are stored in each line of the memory. In another configuration, four M/2-bit coefficients of a polynomial of ML-KEM are stored in each line of memory. In another configuration, one N-bit unshared word of XMSS or LMS data is stored in each line of memory. As with the Type A memory, when higher order masking is required the width of the memory may be increased to accommodate additional shares.

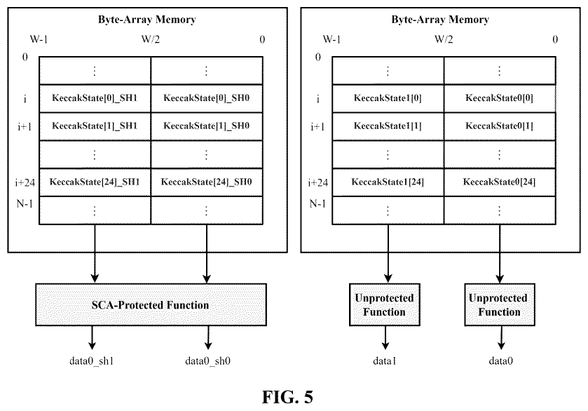

FIG. 5 depicts two possible uses of the SHA-3 hash state. The SHA-3 module is capable of performing a protected hash operation using shared input data as well as performing multiple parallel unprotected hash operations. The second operation is accomplished by treating the two shares of the state as separate states. In one instance, a protected hash operation is performed, and the resulting shared state is used to perform a protected function, such as sampling of the ML-KEM secret polynomials. In another instance, an unprotected hash is performed, and the two states are used to perform two unprotected operations, such as the sampling of the ML-KEM public polynomials. This configuration enables both protected sampling as well as high-throughput unprotected sampling.

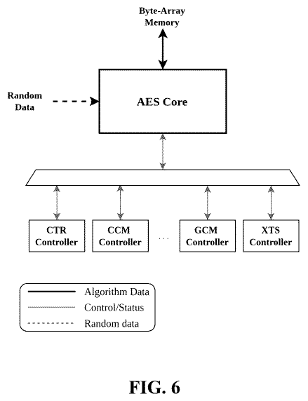

FIG. 6 depicts a possible configuration of the AES modules. The AES module consists of a protected AES core and a set of cipher mode operation controllers. The AES core may optionally support both the encryption and decryption functions or only encryption operation depending on the requirements of the supported cipher modes. Any subset of controllers for the cipher operation modes may be instantiated depending on the needs of the application.

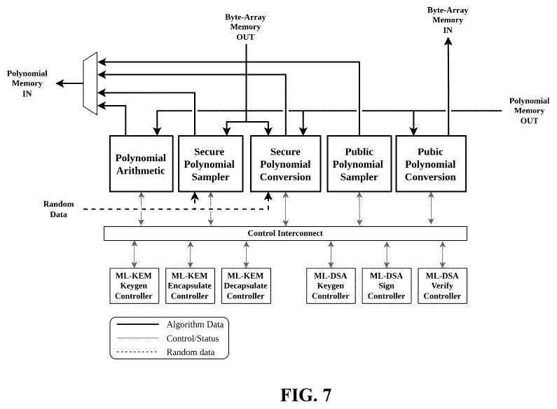

FIG. 7 depicts a possible configuration of the combined ML-KEM and ML-DSA module. The module consists of a set of polynomial sampling and arithmetic units as well as a set of control modules. Depending on the needs of the application, all, or a subset of the operations of ML-KEM and ML-DSA may be instantiated. For example, one application may utilize all functionality of ML-KEM (Key generation, encapsulate, and decapsulate) and only the verify operation of ML-DSA, while another may only utilize the signature generation functionality of ML-DSA.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A low footprint, memory efficient, and hardware architecture configurable to support a plurality of cryptographic hardware modules comprising:
a plurality of side-channel protected hardware modules operably configured to perform at least one side-channel protected cryptographic algorithm;
a first memory module configured to receive and store type A algorithm data from an external interface to the hardware architecture and receive and store the type A algorithm data, wherein the type A algorithm data is configured for use during operation of at least one of the plurality of side-channel protected hardware modules and utilized in the at least one side-channel protected cryptographic algorithm;
a second memory module configured to receive and store type B algorithm data used during operation of the at least one of the plurality of side-channel protected hardware modules and utilized in the at least one side-channel protected cryptographic algorithm;
a random number generator operably configured to generate random data used by the at least one of the plurality of side-channel protected hardware modules;
a plurality of interconnects configured to selectively transfer:
the type A algorithm data between the at least one of the plurality of side-channel protected hardware modules and the first memory module or the first memory module and the external interface;
the type B algorithm data between the at least one of the plurality of side-channel protected hardware modules and the second memory module; and
the random data between the random number generator and the at least one of the plurality of side-channel protected hardware modules; and
a system controller operably configured to manage the selective transfer used by the plurality of interconnects and manage a state of the plurality of side-channel protected hardware modules and a state of the random number generator.

2. The low footprint, memory efficient, and hardware architecture according to claim 1, wherein the system controller is operably configured to manage a state of the first and second memory modules.

3. The low footprint, memory efficient, and hardware architecture according to claim 1, wherein the plurality of side-channel protected hardware modules are operably configured to implement at least one secret key encryption, at least one quantum-resistant public key encryption, and at least one hashing operation.

4. The low footprint, memory efficient, and hardware architecture according to claim 1, wherein the random data is used by the at least one of the plurality of side-channel protected hardware modules for at least one of a side-channel protected operation and a seed generation within the side-channel protected cryptographic algorithm.

5. The low footprint, memory efficient, and hardware architecture according to claim 1, wherein type A algorithm data includes at least one of word-aligned SHA-2 shares, lane-aligned SHA-3 shares, and column-aligned AES shares and type B algorithm data includes at least one of two ML-DSA coefficient shares, four ML-KEM coefficient shares, or one word-aligned of an XMSS or LMS data element.

6. The low footprint, memory efficient, and hardware architecture according to claim 1, wherein the random number generator is operably configured to generate the random data with at least one of:
a PRNG module seeded by an external source of randomness, a PRNG module seeded by an internal TRNG module, or a combined PRNG-TRNG module operably configured with both PRNG functionality and TRNG functionality.

7. The low footprint, memory efficient, and hardware architecture according to claim 1, wherein one of the plurality of side-channel protected hardware modules further comprises:
a SHA-3 module configured to perform, with the type A algorithm data, either a protected SHA-3 hash operation with the entire first memory module 104a or multiple parallel unprotected SHA-3 hash operations with each of the unprotected SHA-3 hash operations utilizing a portion of the first memory module 104a.

8. The low footprint, memory efficient, and hardware architecture according to claim 7, wherein one of the plurality of side-channel protected hardware modules further comprises:
a ML-KEM/DSA module configured to perform public sampling operations using the parallel unprotected SHA-3 hash operations and configured to perform secret sampling operations using the protected SHA-3 hash operations.

9. The low footprint, memory efficient, and hardware architecture according to claim 1, wherein one of the plurality of side-channel protected hardware modules further comprises:
a ML-KEM/DSA module configured to perform a subset of ML-KEM key generation operations, encapsulate operations, and decapsulate operations within the at least one side-channel protected cryptographic algorithm.

10. The low footprint, memory efficient, and hardware architecture according to claim 1, wherein one of the plurality of side-channel protected hardware modules further comprises:
a ML-KEM/DSA module configured to perform a subset of ML-DSA key generation operations, signature generation operations, and signature verification operations within the at least one side-channel protected cryptographic algorithm.

11. The low footprint, memory efficient, and hardware architecture according to claim 1, wherein one of the plurality of side-channel protected hardware modules further comprises:
an AES module configured to perform a subset of encryption operations and decryption operations.

11. The low footprint, memory efficient, and hardware architecture according to claim 1, wherein one of the plurality of side-channel protected hardware modules further comprises:
a XMSS module configured to perform a subset of XMSS key generation operations, signature generation operations, and signature verification operations within the at least one side-channel protected cryptographic algorithm.

12. The low footprint, memory efficient, and hardware architecture according to claim 1, wherein one of the plurality of side-channel protected hardware modules further comprises:
a LMS module configured to perform a subset of LMS key generation operations, signature generation operations, and signature verification operations within the at least one side-channel protected cryptographic algorithm.

13. The low footprint, memory efficient, and hardware architecture according to claim 1, wherein one of the plurality of side-channel protected hardware modules further comprises:
an AES module configured to perform a subset of the following cipher block modes: CTR, CCM, GCM, CFB ECB, CBC, CBC-MAC, and XTS.
